(19) United States
(12) Patent Application Publication
(10) Pub. No.: US 2020/0349858 A1
(43) Pub. Date: Nov. 5, 2020

(54) Method and system of teaching quantum linear theology and method of measuring national and presidential spirit energy using computer and application based timelines

(71) Applicant: Jesse Jackson, JR., Chicago, IL (US)

(72) Inventor: Jesse Jackson, JR., Chicago, IL (US)

(21) Appl. No.: 16/873,469

(22) Filed: Apr. 20, 2020

Related U.S. Application Data
(63) Continuation of application No. 16/350,317, filed on Oct. 31, 2018.

(51) Int. Cl. G09B 19/00; G06F 17/11

(52) U.S. Cl. CPC G09B 19/00; G06F 17/11

(57) ABSTRACT

A method of teaching Quantum Linear Theology (“QLT”) includes instructing a student about a process of developing life guidance utilizing QLT principles and techniques, providing an electronic device configured to assist the student in developing a personal timeline based on QLT principles and techniques, wherein the electronic device has a plurality of source materials to be used by the student to use building a personal timeline, inputting personal data into the electronic device, selecting elements, QLT principles and techniques to align with the personal information of the student, constructing a personal timeline, by the student, from the selected elements of QLT principles and techniques, identifying a daily theological purpose, utilizing the timeline, providing the daily theological purpose and the timeline to an instructor for review, and providing constructive feedback to the student from the instructor on the student's daily purpose based on QLT principles and techniques.

### CROSS REFERENCE TO RELATED APPLICATIONS

The present application is a Continuation-in-Part of U.S. Patent Application Ser. No. 16/350,317, filed on Oct. 31, 2018, the entire contents of which is incorporated herein in its entirety.

### BACKGROUND OF THE INVENTION

### 1. Field of the Invention

The present disclosure relates to a method and system of teaching Quantum Linear Theology and method of measuring spirit energy using computer and application based timelines and primitive methods of instruction for K-12, 12-16, Masters in Theology (MDiv), and Juris Doctorate curriculums. More specifically, a method of teaching a student or pupil utilizing a software-based approach via a computer or mobile device to apply Quantum Linear Theology by developing a personal timeline to provide self-realization and a purpose in life.

### 2. Description of the Background of the Invention

It is part of the human condition to seek out a purpose or direction in life; this was the Founding Fathers intent in their establishment of the life, liberty, and happiness system under God. Commonly, people are searching for a calling in their life that they find fulfilling beyond mere subsistence. One of the most common questions an individual may ask is, “why am I here,” or “what is my purpose in life?” Many people struggle to answer these types of questions, and may feel that they lack direction in life or other types of endeavors. Many people look to historical events, philosophy, religion, science, and/or mathematics for inspiration. People sometimes attempt to relate personal life experiences to inspirational ideas and or events from the past.

However, deep philosophical questions traditionally require intense studies and introspection. Undertaking these types of studies can be difficult and time consuming. Many people have limited knowledge and/or opportunities to learn. Also, there is a vast array of materials ranging from religious texts to books on history and philosophy, which represent an overwhelming and intimidating amount of materials from which to glean information. The materials that can provide sources of inspiration and guidance are also not located and/or consolidated in convenient locations. While the interne allows for quick and easy access to information, the quality of the information found may be suspect and a significant amount of time and effort spent searching is still required, regardless of how quickly a search can occur.

Therefore, there is a need for teaching a method of applying inspirational materials to personal life experiences. More specifically, there is a need for a consolidated source of materials that a person can use to apply inspirational ideas, events, and/or principles to their personal life experiences utilizing a methodology such as Quantum Linear Theology to help build a personal timeline that can be used to determine a purpose and/or direction in life.

### SUMMARY OF THE INVENTION

According to one aspect, a method of teaching Quantum Linear Theology that includes instructing a student at the earliest stages of cognitive development during K-16 studies, about a process of developing life guidance utilizing Quantum Linear Theology principles and techniques, providing an electronic device configured to assist the student in developing a personal timeline based on Quantum Linear Theology principles and techniques, wherein the electronic device has a plurality of source materials to be used by the student to use building a personal timeline, inputting personal data, by the student, into the electronic device, selecting elements, by the student, from Quantum Linear Theology principles and techniques to align with the personal information of the student, constructing a personal timeline, by the student, from the selected elements of Quantum Linear Theology principles and techniques, identifying a daily theological purpose, by the student, utilizing the timeline, providing the daily theological purpose and the timeline to an instructor for review, and providing constructive feedback to the student from the instructor on the student's daily theological purpose and the timeline for improving the timeline based on Quantum Linear Theology principles and techniques.

### BRIEF DESCRIPTION OF THE DRAWINGS

FIG. 1 depicts a flow chart of the entire K-16, MDiv/JD curriculum illustrating a method of teaching Quantum Linear Theology to a student utilizing an electronic device;

FIG. 2 depicts a chart illustrating another method of teaching Quantum Linear Theology Lineage of Abraham (LOA), to a student utilizing an electronic device;

FIG. 3 depicts a generational chart that illustrates various generations from Jesus to Abraham;

FIG. 4 depicts the Lineage of Abraham;

FIG. 5 depicts the Lineage of David;

FIG. 6 depicts a generational chart and its connection with COTAARP;

FIG. 7 depicts another generational chart and its connection with COTAARP;

FIG. 8 depicts the Lineage of David and its connection with COTAARP;

FIG. 9 depicts COOTARP and its connection to various U.S. Presidents;

FIG. 10 depicts the Lineage of David and its connection with COTAARP;

FIG. 11 depicts the 1st Amendment of the U.S. Constitution and its connection with COTAARP;

FIG. 12 depicts COTAARP and its connection to the 2020 U.S. Presidential Election; and

FIG. 13 depicts various historical figures and their connection with COTAARP.

Other aspects and advantages of the present invention will become apparent upon consideration of the following detailed description.

### DETAILED DESCRIPTION

Through the teaching and application of Quantum Linear Theology (“QLT”) principles, a personal timeline can be built starting at kindergarten, which can be used to determine a purpose and/or direction in life through high school, college, and beyond. The principles and methods disclosed below may be modified so as to be utilized by different groups or subsets of the population, which may be organized through one or more categories such as students, veterans, clergy, elected officials, and public servants etc. For example, elementary school students, high school students, undergraduate college students, and graduate students may all be taught how to develop a personal timeline utilizing the principles of QLT, but the sophistication of the QLT instruction may be reduced for certain subsets, for example, high school students and under. Conversely, other subsets of the population, such as graduate students, likely would be expected to understand the more sophisticated principles. Many of the guiding principles and teachings of QLT are described below in detail hereinafter below.

The Founding Fathers of the United States play an important role in QLT. Another important aspect of QLT as described below is the application of mathematical principles to religious scripture and ideas. The combination of historical references and biblical information as directed by QLT provides a basis for a student to learn how to develop a personal timeline that can be used to determine a purpose and direction in life.

The construction of a Global Linear Theological System will now be explained in more detail. At the heart of Quantum Linear Theology is The God of the Linear System. The first commandment among the Ten Commandments delivered to Moses is thus, “I am the Lord thy God, which have brought thee out of the land of Egypt, thou shall have no other God before me.” The first of the two great commandments offered by Jesus of Nazareth at the end of the lineage of Abraham is to love “One God with all of one's heart, soul, and mind.” “Liken unto it is a second commandment to love one's neighbor as one's self, and all of the laws from Abraham to Jesus are built upon the prophets.” For Thomas Jefferson, this is the sum of all religions. In the New Testament, Matthew 1:1-17, moves a believer through a bloodline and spirit-line from Abraham to Jesus, 42 generations. Most believers spend minimal time studying this lineage. The Founding Fathers of our country believed in this lineage and the linear theological system. The Founders theology was central to their new country on Sep. 17, 1787. In the Old Testament, David was a poor shepherd boy that stood against Goliath and armed with a slingshot and a rock defeated the Philistine army by sleighing its champion. David was elevated, “to command the army” before he became King. There are 14 generations from Abraham to David and 28 Generations from David to Jesus of Nazareth.

### The Lineage of David

When Jesus of Nazareth comes on the scene, he is born the son of a poor carpenter, the son of Joseph and Mary. Jesus' ministry around the Sea of Galilee centered around love and forgiveness, compassion and mercy. Among the greatest stories and moral lessons in the New Testament are those of Jesus asking a repentant and redeemed thief, murderer and prostitute to transfer their guilt both public and private to him. In consideration for the transfer of guilt he offered them forgiveness and the promise of a new redeemed life, “on earth as it is in heaven.” The power of forgiveness and new life allowed the people that Jesus touched to achieve a new psychological freedom and break the crippling cycle of shame, blame and guilt of poor felonized Galileans. For once the guilt was removed, rebirth and human liberty became infinitely possible. Shame, blame and guilt was defeated in the psychology of a people. In Jesus of Nazareth's present, he offered full and complete, mercy and forgiveness, “reprieves and pardons,” by extending the promise of a new life to the felons of his day. He offered them an opportunity to change their lives and behavior and find happiness in a “New Israel.”

The Quantum leap is from triangular theological systems and mythological theological systems to a linear theological system with a daily life of purpose in the present, away from the mythological and triangular systems to systems that focus on the present, the now, to fulfil the purpose of love of one God in the linear system. The God of Abraham, Ismael, Isaac, Jacob, David, and Jesus of Nazareth is a linear system. By making this leap to QLT, followers will find that achieving purpose in the present as a student comes naturally. Also, while achieving purpose, an understanding of the contemporary needs of humanity can be developed by a journeyman student exploring QLT under their unique star.

The architects of our republic settled the theological question of Ismael's absence from the biblical lineage systems by not excluding him or his decedents from the first amendment. The architects of our republic, i.e., the founding fathers, provide a wealth of information quotes and writings that may be used as part of finding one's purpose in the life, liberty, and happiness system. A variety of examples that are useful and enlightening in the context of the teaching method are provided below.

Linear theological systems and quantum linear equations will now be explained in more detail. First, the difference between trinitarian theology and the linear theological system of Mathew 1:1. Among the then-known religion(s) explored by the architects of our republic, which includes Islam, Judaism, and Christianity, there exists a linear system in Matthew 1:1 that details every prophet from Abraham to Jesus of Nazareth connected by an addition symbol, i.e., “+”. There are 42 generations between Abraham and Jesus of Nazareth. Thus, the sum of these 42 generations comprises the sum total of all of the prophets, and their teachings from Abraham to Jesus of Nazareth for which Jesus of Nazareth speaks specifically about in the Great Commandments.

“To love one God with all of one's heart, soul, and mind, and one's neighbor as one's self, and all laws are built upon the prophets” is the sum of religion according to Thomas Jefferson the architect of our republic. If the sum of the teachings of the lineage of Abraham is the will of God, then the sum of the lineage of Abraham and its teachings equals infinity If the sum of the lineage of David equals the teachings of the lineage of Abraham, then the sum of the lineage of David as a subset of the lineage of Abraham also equals infinity. If the sum of the lineage of David equals infinity, then the sum of the function of the lineage of David equals infinity. The sum of the lineage of David being the lineage of David and Jesus by function, for one man in a sect or a religion by himself elected by the people. These mathematical relationships will be described in more detail below.

Now turning to the linear theological system of Abraham. The Lineage of Abraham (LOA) may be described via the following equation:

Thus, the LOA is equal to the sum from Abraham to Jesus of Nazareth by the integral of the time of spirit energy from zero to infinity, which equals infinity. The book of Matthew is the oldest book in the Bible. Matthew 1:1 begins with a lineage from Abraham to Jesus of Nazareth, and that lineage includes 42 generations. The sum of all of the teachings of Abraham to Jesus of Nazarath is the sum of all of the teaching of the prophets. That is, integrating from zero to infinity the time spirit of energy of all the teachings of each generation of the LOA and summing each generation together results in a value of infinity. An infinite amount of spirit energy can be extracted by and through the study of the LOA via QLT philosophy. Now turning to the Lineage of David and the Functional Extract of the Lineage of David (“LOD”) as a Functional Extract from the Linear Theological System of Abraham.

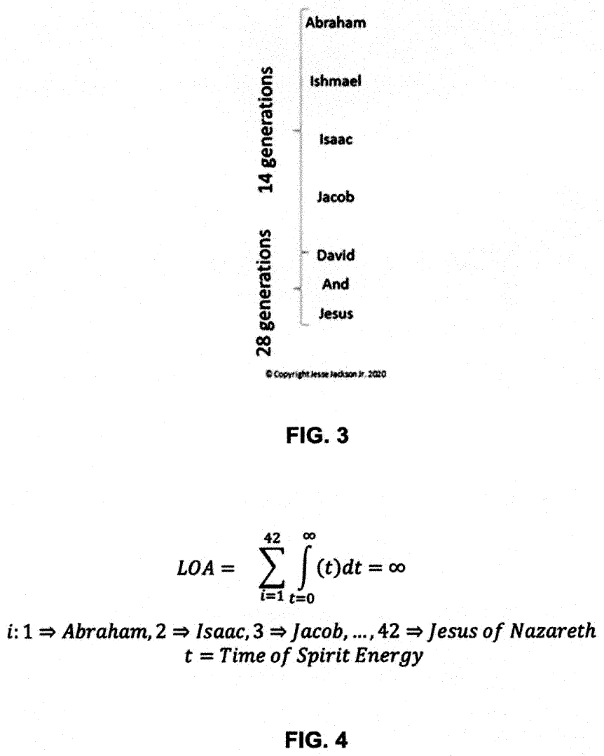

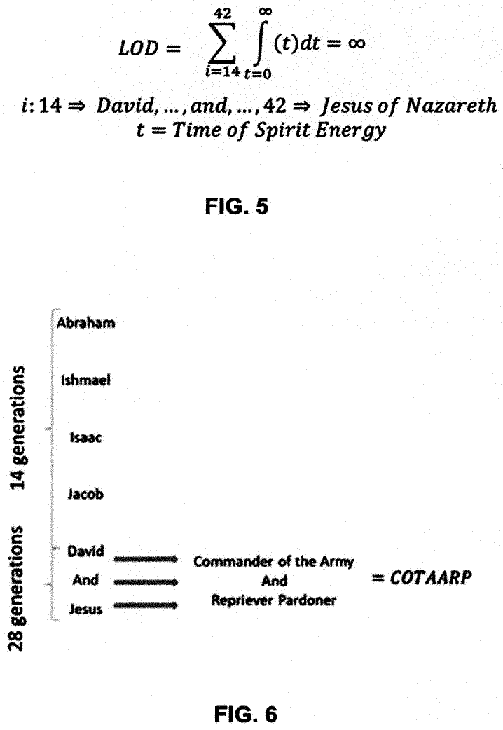

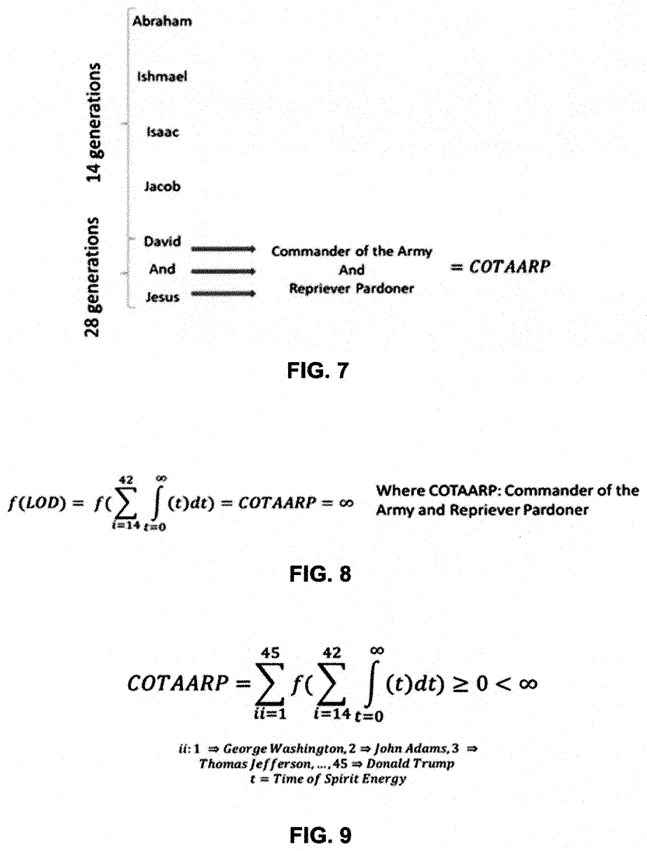

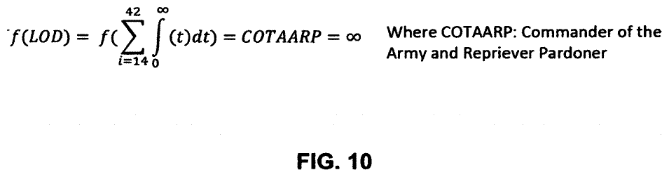

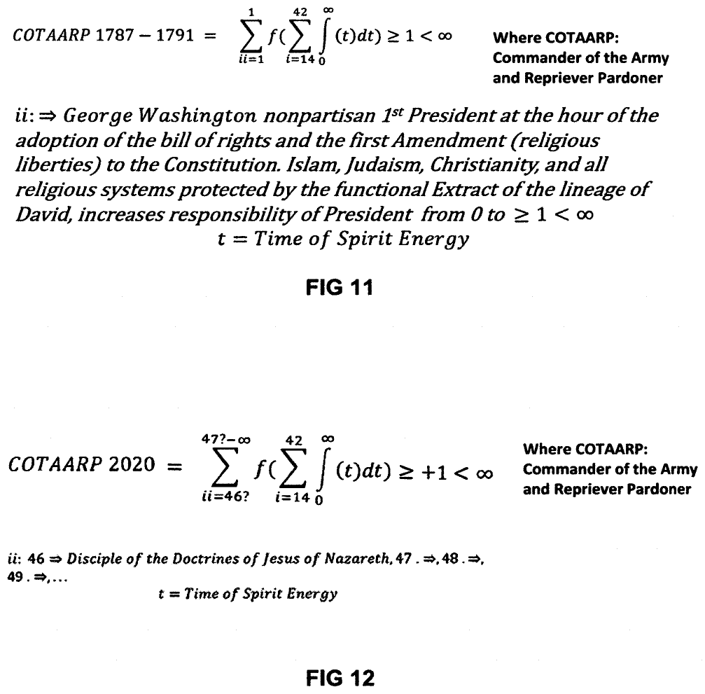

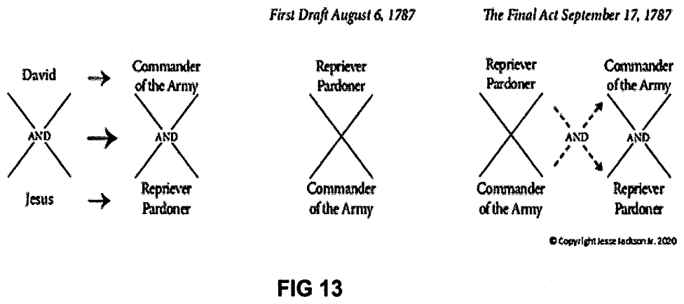

The (LOD) the Lineage of David may be expressed mathematically as a subset of the Lineage of Abraham (LOA) as depicted in FIG. 3.

Thus, the Lineage of David equals the sum from David to Jesus of Nazareth by the integral of the time of spirit energy from zero to infinity, which equals infinity. There are 14 generations from Abraham to David. From David to the Babylonian Captivity there are 14 generations. From the Babylonian Captivity to Jesus, there are also 14 generations. Therefore, from Abraham to David is 14, David to Babylonian Captivity is another 14 (28), and Babylonian captivity to Jesus is another 14, the grand sum being 42. So, between David and Jesus of Nazareth, there are 28 generations, and that is where the LOD equation comes into play. Hence, i=14, and 42 represents David to Jesus of Nazareth. The integral of the time spirit of energy of all the teachings of each generation summed over those 28 generations is also equal to infinity.

As described above, the LOD may be discussed as a subset of the LOA. That is, the LOA is the integral of the time of spirit energy summed over all the generations from Abraham to David and to Jesus. Therefore, the LOD is a subset of LOA. The first 12 generations of the LOA exclude Ishmael (of whom Mohammad is a future descendent) and thus the biblical LOA Matthew 1:1 serves as the foundation of Judaism, and Christianity. The founding fathers extracted Commander of the Army and Repriever Pardoner (COTAARP) from said lineage by function. Democrats and Republicans has treated this theological concept as two job descriptions, but it is not. It is a single theological concept extracted from infinity.

Jefferson, who referred to himself, “as a disciple of the doctrines of Jesus of Nazareth” bought two copies of the bible, and he extracted Jesus' life from the beginning of Jesus' life to the Crucifixion as recorded in Matthew, Mark, Luke and John, and synthesized the account of Jesus life into a single narrative in Greek, Latin, French, and English. Jefferson then put these extractions into a book entitled “The Life and Morals of Jesus of Nazareth Extracted Textually from the Gospels in Greek, Latin, French, and English.” Jefferson in his demythologized version for his disciple arrives at the birth of Jesus not by a virgin, but bourn to Joseph and Mary because he was of the house and Lineage of David. This foundational thought in QLT will be discussed in greater detail hereinafter below.

It is contemplated that there is a first linear theological equation that forms a basis for the beginning of QLT. The first equation is based upon a fundamental principle “that rebellion to tyrants is obedience to God.” “If, rebellion to tyrants is obedience to God, and God equals infinity, then rebellion to tyrants is therefore infinite obedience to God.” It is also contemplated that infinity as a time constant relationship with God. Infinity may be defined by other variables. For example, love, grace, mercy, forgiveness, redemption, hope, life, liberty, and self-sacrifice may all be held as infinity constants.

Turning now to the QLT, the basis of which is found in the constitution and the presidential powers. Specifically, the Commander of the Army and Repriever Pardoner (COTAARP) as a functional extract of LOD extracted from the linear theological system of Matthew 1:1

Jefferson referred to himself as being in a Sect of 1. Here, Jefferson is referring to the aforementioned equation. Now we turn our attention to the grand sum of the integral of spirit energy of 45 presidents whose spirit energy without the recognition of the COTAARP has amounted to political activity and not morally guided spiritual activity. This is defined in the following equation as the sum of their energy being greater than or equal to 0 but less than infinity:

If the COTAARP is equal to the functional extract of the LOD, i.e., James Madison's “finger of the almighty hand” (Federalist #37) and Alexander Hamilton's “finger of God” (Federalist #74), which has been extracted from the linear theological system of Mathew 1:1, then it is therefore theological DNA from the linear systems of God of Abraham, Ishmael, Isaak, Jacob, David, and Jesus of Nazareth. (see image below striking the redundancy language of Alexander Hamilton in Federalist #74).

One aspect of the COTAARP in QLT is that the value changes over time as the nation progresses through history. For example, when George Washington was President during the adoption of the Bill of Rights, the value of COTAARP changed from 0 to a value equal to or greater than 1 and less than infinity. With the addition of the 1st Amendment in 1791 George Washington and successive Presidents had to represent more Religious points of view than their original design.

The COTAARP between 1787 and 1791 is the addition of the first amendment by the people to the Constitution, ii=1 inferring George Washington, and because he was president, he functions as a disciple in the LOD. With the Functional Extract of the Lineage of David, (whatever his personal religion was) resulted in a COTAARP value that is greater than or equal to 1, but less than infinity. Whatever George Washington's personal religion was with the 1^{st} Amendment to the Constitution Islam and other religious systems were welcomed in the American body politic. As successive presidents occupy the white house, the COTAARP spiritual energy expands to become ever more inclusive. It is also contemplated that calculating the COTAARP going forward from the current point in time is a time value.

The next president will be the 46th president of the United States. This will represent a chance for a new beginning in QLT. It may take time to move the country in this direction, but it assuredly will move. If not with the next president, then the one after that. Eventually it will happen. Because COTAARP is a function of the LOD, the next president is plus one, I have defined the COTAARP function of the LOD +1 for he is going to carry the guilt of 68 million felons. The COTAARP is in the Constitution 4 years before the Bill of Rights and the 10^{th} Amendment, allowing the President of the United States to extend the grace of God not only to Federal offenders but State offenders. A major rebellion to our current thinking. The next president is going to forgive them at the beginning of his administration, meaning that he will give everyone a second chance, “on earth as it is in heaven.” This will represent the beginning of the adoption of a greater QLT system, a return to the public religion of the United States.

Another important aspect of QLT that is still developing is the nature of DNA and DNA coding to determine intrinsic properties and behaviors of a person. Recently, it was revealed that enough DNA has been collected by several genealogy companies that at least one-third of the country could be identified via DNA donated by relatives. It is only a matter of time before everyone can be identified through relatives DNA and that the understanding of DNA and traits that can be attributed to DNA are incorporated into QLT timelines. Students and practitioners of QLT may be able to take a DNA test and have the results become part of their personal timelines. It is also contemplated that as the national repository of DNA grows, it may be possible to work backwards and determine specific lineages that go back in time. Thus, QLT practitioners may be able to use their DNA to help select significant historical people and that are part of their lineage to help form their personal timeline.

The QLT system is a fifty year experiment that began in the faith of the Founding Fathers and their belief in 1 God. the God of Abraham Issaak Jacob and Jesus of Nazareth. The experiment began before the Declaration of Independence and its first phase culminated in the signing of the document on Jul. 4, 1776. Immediately after the signing, John Adams, Benjamin Franklin, and Thomas Jefferson, were appointed to the Great Seal Committee to memorialize the event in heraldry. While their visions did not become the “Official Seal of the United States,” nevertheless their visions come closest to the original intent of the architects in understanding the “original intent of the Declaration” and ultimately the Constitution itself. After the Constitutional convention, James Madison in Federalist #37 speaks of the presence of the Finger of God in the Constitution, Alexander Hamilton in Federalist #74 manipulates language in the “Finger of God” that he calls a “redundancy.” Later Hamilton would proclaim, “For my part, I sincerely esteem the Constitution, a system which without the Finger of God, never could have been suggested and agreed upon by such a diversity of interests.” QLT is not only a system and of method of instruction it is also “the discovery of the Finger of God in the Constitution” itself and the very system that Hamilton speaks of as the foundation, without which, there “never could have been suggested and agreed upon by such a diversity of interests.” In short, there would be no Constitution. The QLT system, then analyses, the correspondence of John Adams and Thomas Jefferson, both of whom were not in attendance at the convention, but spent the next 50 years of their lives analyzing and researching the character traits of an ideal leader, whose “life and morals” would be consistent with the architects “original intent.”

Immediately after the Declaration of Independence the image below depicts the use of a “primitive method of instruction,” the “chalkboard” for k-12 instruction.

The following image using the primitive system depicts the evolution of the Great Seal away from the original intent to the present design of the Great seal of the United States.

From the Declaration of Independence to the first draft of the constitution, the architects engage in a process of shielding, the theological concept, until what James Madison would call the Final Act was adopted on Sep. 17, 1787, the theological and religious character of the architect of the constitution, James Madison is captured plainly in the following two quotes, “We have staked the whole future of our new nation, not upon the power of government; far from it. We have staked the future of all our political constitutions upon the capacity of each of ourselves to govern ourselves according to the moral principles of the Ten Commandments.”

### James Madison

“Whilst we assert for ourselves a freedom to embrace, to profess and observe the Religion which we believe to be of divine origin, we cannot deny equal freedom to those whose minds have not yet yielded to the evidence which has convinced us. If this freedom be abused, it is an offense against God, not against man: To God, therefore, not to man, must an account of it be rendered.”

The QLT system teaches Commander of the Army and Repriever Pardoner, not as two job responsibilities, but as a single thought, a single idea, a single character trait of 42 generations of the Lineage of Abraham, and more specifically, the governing Lineage of said Lineage by extraction, the final 28 generations of the Lineage of David, that culminated in the evident character traits of Jesus of Nazareth. For the Founding Fathers this character was to be an avatar for the American people by election in the original republic, the ‘original intent.”

The teaching method, which will be described in greater detail, subscribes to each individual personal detailed construction of a timeline they acknowledge and attest to from a period of knowing until the present. The construction of the timeline ultimately enables the student to determine the path they intend to follow forward or to review the past to determine how they arrived in the present. It is a living document, because of the thought given to one's honest and truthful existence they can look at a timeline and determine which path they want to choose next.

The method of teaching QLT will now be explained in more detail. Every human being has a birthdate and an expiration date. Every day in between matters. Whether copied or created in a journal, parental stories and memories, or most importantly for the teaching method, the external, uncontrollable factors that impact every single life can form a basis or portion of a purpose. The air we breathe is part of environmental factors. The education we receive, whether public or private, well-funded or inadequately funded matters and affects the outcome of a purpose in life. Whether the education is diverse or segregated or integrated matters. Whether it is in a low-income community or a community that pays a significant amount of money for a high-quality education matter. In short, in the linear system, every single day, the internal factors, i.e. healthcare, breakfast lunch and dinner, two loving parents in a household or whether a child is abandoned or orphaned, all of these contributing factors are a part of the linear system of the individual's life that are contributing factors to their education and cannot be ignored. Therefore, from birth until the expiration of one's life, there exists a linear line whose trajectory can be altered by the inclusion of various factors; social, economic, environmental are among the factors that can influence the trajectory of that life.

The uniqueness of the teaching method is that each person is born into a purpose and within a star. The stars in the heaven above will never realign themselves in the exact same position at the millisecond of one's birth. The uniqueness of a person's understanding of who they are is at the heart of the teaching method. No single person's timeline will ever be the same, no timeline will be the same within the same family, no timeline will be the same within siblings, and no one in the same household has the same timeline. The recognition of a person's star matters as part of the development of a timeline.

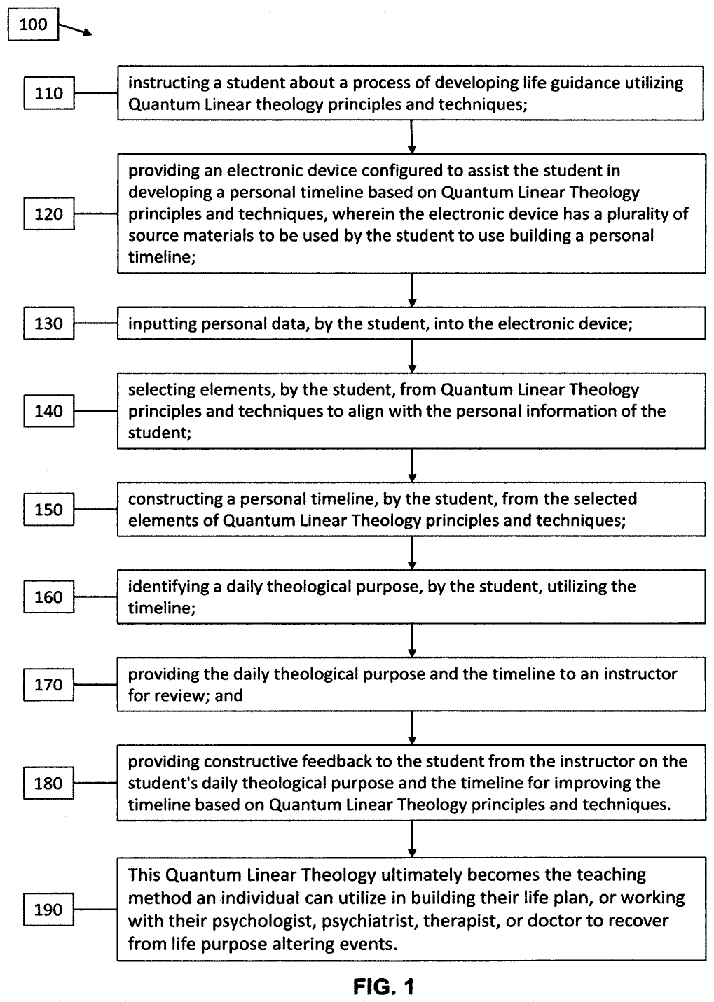

The method of teaching Quantum Linear Theology 100 as described below is depicted in the flow chart of FIG. 1. During the first step 110, a student is instructed about the process of developing life guidance utilizing Quantum Linear Theology principles and techniques. This is a substantial amount of training covering all of the history and math associated with QLT. At a second step 120, the student is provided with an electronic device configured to assist the student developing a personal timeline based on QLT principals and techniques, wherein the electronic device has a plurality of source materials to be used by the student while building a personal timeline. At a third step 130, the student inputs personal data into the electronic device. At a fourth step 140, the student selects elements from QTL principals and techniques that align with the personal information and/or events of the student's life. At a fifth step 150, the student constructs a personal timeline of events, elements, and/or inspirational items from the selected elements of QLT. At a sixth step 160, the student utilizes the timeline to identify a daily theological purpose. At a seventh step 170, the student's daily theological purpose and timeline are provided to an instructor for review. At an eighth step 180, constructive feedback is provided to the student from the instructor on the student's daily theological purpose and timeline. The purpose of the feedback is to improve the timeline based on QLT principles and techniques.

The method of teaching Quantum Linear Theology 100 as described above may include the following steps also. The student may consider constructive feedback from the instructor. In response to constructive feedback, the student may modify the personal timeline or the daily theological purpose or both. This Quantum Linear Theology ultimately becomes the teaching method an individual can utilize in building their life plan, or working with their psychologist, psychiatrist, therapist, or doctor to recover from life purpose altering events.

It is contemplated that the electronic device may be any type of computer or mobile electronic device including but not limited to a handheld mobile device, a smartphone, a tablet computer, a laptop computer, a netbook, or a desktop computer. Also, it is further contemplated that the interface may be a website, a web interface, and/or an application that can be accessed via a mobile electronic device such as a smartphone. The student's personal information and timeline may be stored online and/or in the cloud and the student may be able to access that information and interact with the timeline from a variety of devices and locations. Furthermore, the student may be able to submit the daily theological purpose and timeline for review electronically and receive the feedback electronically.

The development of the timeline is predicated on the student creating a personal timeline of events from their birth to the present time. The events that go on the timeline represent significant points of development of the student. From personal events such as the last interaction with a loved one before passing to graduating from school or a first day on a new job. Then, the students select elements of significance identified by the teachings of QLT or they use the principles of QLT to define new elements. The elements selected should relate to the student on a personal and emotional level with regards to the personal event. When the student contemplates the teachings of QLT and selects elements, those elements should provide spiritual teaching a guidance for the daily theological purpose. It is contemplated that as the student grows and develops the daily theological purpose may change and develop over time. The history of the person's ancestry, the lineage via health, and culture, and the spirit by which they live are the layers that construct each timeline into an individual linear system. In such a system an adult can become a child again and therefore each student is reborn and can correct and continuously redefine their life's purpose.

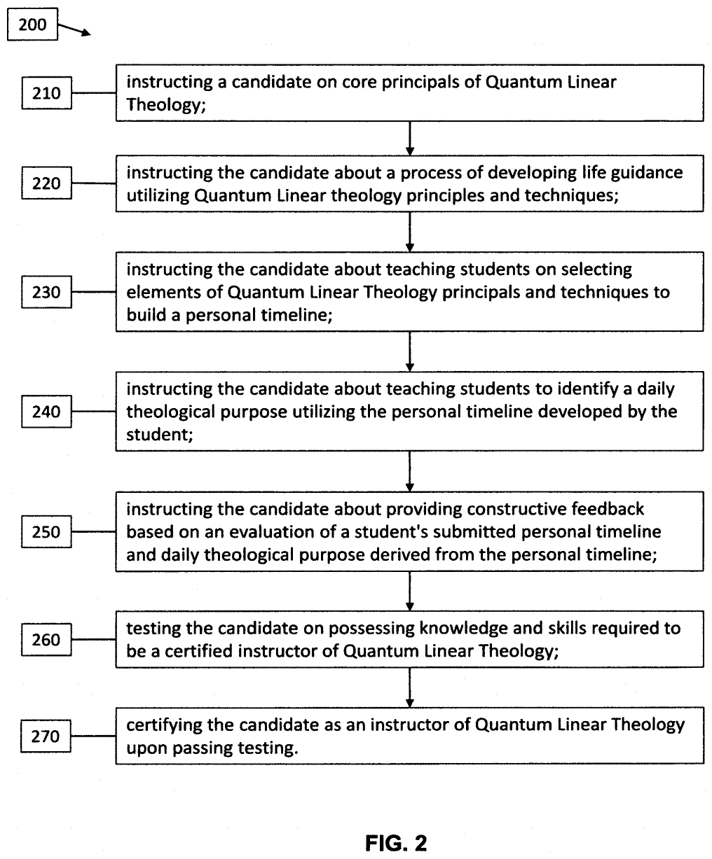

It is also contemplated that a person may be certified as an instructor and teach QLT. The method of teaching an instructor of Quantum Linear Theology 200 as described below is depicted in the flow chart of FIG. 2. During the first step 210, an instructor candidate is instructed in the core principles of QTL. At a second step 220, the instructor candidate is instructed about a process of developing life guidance utilizing Quantum Linear theology principles and techniques. At a third step 230, the instructor candidate is instructed about teaching students on selecting elements of Quantum Linear Theology principles and techniques to build a personal timeline. At a fourth step 240, the instructor candidate is instructed about teaching students to identify a daily theological purpose utilizing the personal timeline developed by the student. At a fifth step 250, the instructor candidate is instructed about providing constructive feedback based on an evaluation of a student's submitted personal timeline and daily theological purpose derived from the personal timeline. At a sixth step 260, the instructor candidate is tested on possession of the knowledge and skills required to be a certified instructor of QLT. At a seventh step 270, the instructor candidate is certified as an instructor of QLT upon passing the testing in step 260.

It is further contemplated that certified instructors of QLT will need to periodically recertify and participate in continuing education training. The recertification process may be as follows. First, continuing education and training on QLT and instruction QLT to students is provided. Second, the instructor seeking recertification is tested on the possession of knowledge and skill required to be certified instructor of Quantum Linear Theology, the continuing education and training on Quantum Linear Theology, and instructing Quantum Linear Theology to students. Third, upon passing the testing, the instructor is recertified as an instructor of QLT. It is contemplated that the recertification may be repeated every three to five years. It is also contemplated that the QLT may be taught at Christian, Islamic, and Judaic institutions of higher learning, including churches, mosques and synagogues. The instructors at the aforementioned institutions will need to be certified and periodically recertify as instructors of QLT. It is also contemplated that local and national political parties, such as Democrat and Republican political parties, but not limited to them, may require instruction and certification and recertification in the QLT system.

It is further contemplated that principals of the QLT system may be incorporated into cinematic and/or theatrical adaptations for the purposes of entertainment and/or education. It is also contemplated that the principals of the QLT system may be incorporated in whole or in part into documentaries, dramas, on and off screen performances that require legal permission, including but not limited to licensing. Such licensing or other arrangements may be available for nonprofit and for profit entities.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out the same. The exclusive rights to all modifications which come within the scope of the appended claims are reserved.

The National Institute for the Study of the Public Religion of the United States (NISPRUS) and National Centers for the Study of the Public Religion of the United States (NCSPRUS) is the central organization of the QLT system. QLT's national training system is similar to the National Institute structure like that of the National Institute of Health. NISPRUS is the certifying and recertifying body of the QLT system and NCSPRUS are centers established through a licensing, certification and recertification process that allows quality control of instruction at institutions that range from K-12 to College and Universities, to Graduate and Postgraduate Studies.

I claim:

1. A method of teaching Quantum Linear Theology, the method comprising:
instructing a student, K-12, about a process of developing life guidance utilizing Quantum Linear Theology principles and techniques;
providing an electronic device configured to assist the student, K-12, in developing a personal timeline based on Quantum Linear Theology principles and techniques, wherein the electronic device has a plurality of source materials to be used by the student to use building a personal timeline;
inputting personal data, by the student, into the electronic device;
selecting elements, by the student, from Quantum Linear Theology principles and techniques to align with the personal information of the student in elementary, high school and graduate school;
constructing a personal timeline, by the student, K-12, from the selected elements of Quantum Linear Theology principles and techniques;
identifying a daily theological purpose, by the student, in grades K-12, utilizing the timeline;
providing the daily theological purpose and the timeline to an instructor for review; and
providing constructive feedback to the student, in grades K-12, from the instructor on the student's daily theological purpose and the timeline for improving the timeline based on Quantum Linear Theology principles and techniques.

2. The method of claim 1 further comprising:
providing a web interface configured to be accessed by the electronic device, wherein the electronic device is one of a handheld mobile device, a smartphone, a tablet computer, a laptop computer, a netbook, or a desktop computer.

3. The method of claim 1 further comprising:
consideration of the constructive feedback from the instructor by the student;
modifying at least one of the personal timeline or the daily theological purpose by the student in response to the constructive feedback.

4. A method of teaching an instructor of Quantum Linear Theology, the method comprising:
instructing a candidate on core principles of Quantum Linear Theology;
instructing the candidate about a process of developing life guidance utilizing Quantum Linear theology principles and techniques;
instructing the candidate about teaching students on selecting elements of Quantum Linear Theology principles and techniques to build a personal timeline;
instructing the candidate about teaching students to identify a daily theological purpose utilizing the personal timeline developed by the student;
instructing the candidate about providing constructive feedback based on an evaluation of a student's submitted personal timeline and daily theological purpose derived from the personal timeline;
testing the candidate on possessing knowledge and skills required to be a certified instructor of Quantum Linear Theology; and
certifying the candidate as an instructor of Quantum Linear Theology upon passing testing.

5. The method of claim 4 further comprising:
providing continuing education and training on Quantum Linear Theology and instructing Quantum Linear Theology to students;
testing the instruction on the possession of knowledge and skill required to be certified instructor of Quantum Linear Theology, the continuing education and training on Quantum Linear Theology, and instructing Quantum Linear Theology to students; and
recertify the instructor as an instructor of Quantum Linear Theology upon passing the test.

6. The method of claim 5, further comprising:
repeating the steps of claim 5 every five years to recertify in the latest developments of Quantum Linear Theology.
